(19) United States
(12) Patent Application Publication
(10) Pub. No.: US 2025/0316920 A1
(43) Pub. Date: Oct. 9, 2025

(54) POWER CONNECTOR WITH IMPROVED TERMINALS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: Shuo-Hsiu HSU, Phoenix, AZ (US); Ming-Lun Szu, New Taipei (TW)

(21) Appl. No.: 18/630,393

(22) Filed: Apr. 9, 2024

(51) Int. Cl. H01R 13/422; H01R 12/71; H01R 13/05; H01R 13/11

(52) U.S. Cl. CPC H01R 13/4223; H01R 12/716; H01R 13/055; H01R 13/112

(57) ABSTRACT

A power plug connector includes: an insulating housing defining a mating face and having plural passageways through the mating face, each of the passageways having a receiving hole and two retaining slots at opposite sides of the receiving hole; and plural plug terminals each received in a corresponding passageway, wherein each of the plug terminals is composed of two distinct terminal pieces each comprising a retaining portion retained in a corresponding retaining slot, a blade contacting portion extending from the retaining portion and protruding out of the mating face, and a leg portion.

### BACKGROUND OF THE INVENTION

1. Field of the Invention

The present invention relates to a power connector with improved terminals.

2. Description of Related Arts

U.S. Pat. No. 7,976,317 B2 discloses a power connector module which includes a plug connector and a mating receptacle connector. Each connector has an uncoupled contact feature. The uncoupled contacts have exposed surfaces to dissipate heat resulting from Joule effects. The uncoupled contacts for the plug connector converge to form a blade structure at one side. The uncoupled contacts for the receptacle connector form a receiving section that engages the blade structure of the plug connector when the plug connector and receptacle connector are used together. The power connector modules are not suitable for some specific applications.

Therefore, an improved electrical connector is desired to overcome the disadvantages of the prior art.

### SUMMARY OF THE INVENTION

An object of the present invention is to provide a power connector with improved terminals.

In order to achieve above-mentioned object, a power connector assembly comprises: a plug connector comprising an insulating housing defining a mating face and a mounting face opposite to the mating face and having a plurality of retaining passageways, and a plurality of plug terminals each comprising a retaining portion retained in the passageways, a blade contacting portion extending from the retaining portion and protruding outwards the mating face of the insulating housing; and a receptacle connector comprising an insulating housing defining a mating face and a mounting face opposite to the mating face and having a plurality of passageways and a plurality of receptacle terminals received in the passageways and hid below the mating face of the receptacle connector, each of the passageways comprising a receiving hole and two retaining slots, wherein each of the receptacle terminals is composed of two distinct terminal pieces, each of the terminal pieces comprising a retaining portion retained in the retaining slot, an elastic arm with an arc contacting portion, and a leg portion extending out of the insulating housing of the receptacle connector, and the two elastic arms are located opposite to each other and commonly received in a corresponding one of the receiving holes.

A power plug connector comprises: an insulating housing defining a mating face and having a plurality of passageways running through the mating face, each of the passageways comprising a receiving hole and two retaining slots at opposite sides of the receiving hole; and a plurality of plug terminals each received in a corresponding passageway, wherein each of the plug terminals is composed of two distinct terminal pieces each comprising a retaining portion retained in a corresponding retaining slot, a blade contacting portion extending from the retaining portion and protruding out of the mating face, and a leg portion.

### BRIEF DESCRIPTION OF THE DRAWING

FIG. 1 is a perspective view of a power connector assembly including a plug connector and a receptacle connector disconnected from each other, of a first embodiment of the present invention;

FIG. 2 is a cross-sectional view of the assembly in FIG. 1, wherein the plug connector and the receptacle connector are mated with each other r;

FIG. 3 is an exploded perspective view of the receptacle connector in FIG. 1;

FIG. 4 is another exploded perspective view of the receptacle connector in FIG. 3;

FIG. 5 is a perspective view of a power connector assembly including a plug connector and a receptacle connector disconnected from each other, of a second embodiment of the present invention;

FIG. 6 is a cross-sectional view of the assembly in FIG. 6, wherein the plug connector and the receptacle connector are mated with each other r;

FIG. 7 is a partly exploded perspective view of the plug connector in FIG. 5; and

FIG. 8 is another exploded perspective view of the plug terminal in FIG. 7.

### DETAILED DESCRIPTION OF THE PREFERRED EMBODIMENTS

Reference will now be made in detail to the preferred embodiments of the present invention.

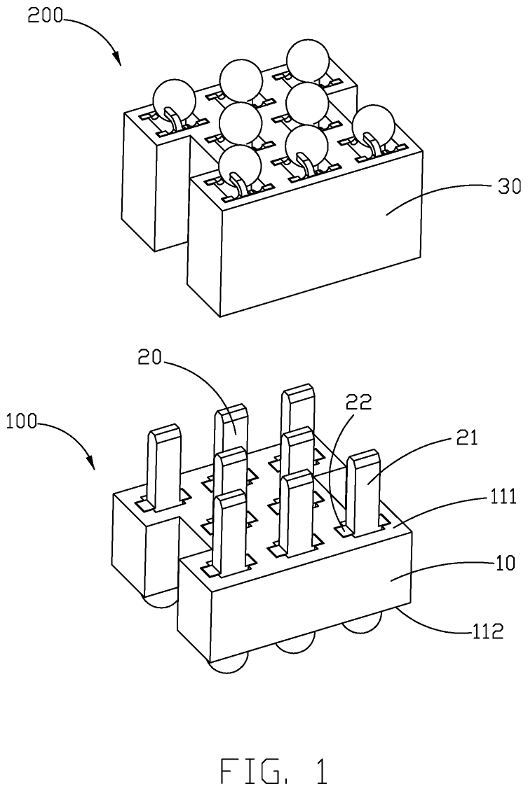

Referring to FIGS. 1-4 illustrating a power connector assembly of a first embodiment of this present invention, the assembly includes a plug connector 100 and a receptacle connector 200, the plug and the receptacle connectors each includes an insulating housing with a mating face and a plurality of conductive terminals retained in the insulating housing. The plug connector 100 has a plurality of plug terminals 20 protruding upwards beyond a mating face 111 of the insulator housing 10, the second connector 200 has a plurality of receptacle terminals 40 retained in the passageways 32 defined in an insulating housing 30 and hide below a mating face 311 of the insulating housing 30. When the two connectors are mated with each other, the two mating faces 111, 311 confront with each other, the plug terminals 20 are inserted in the passageways 32 of the receptacle connector and contact with the receptacle terminals 30 to achieve electrical connection between two printed circuit boards (not shown).

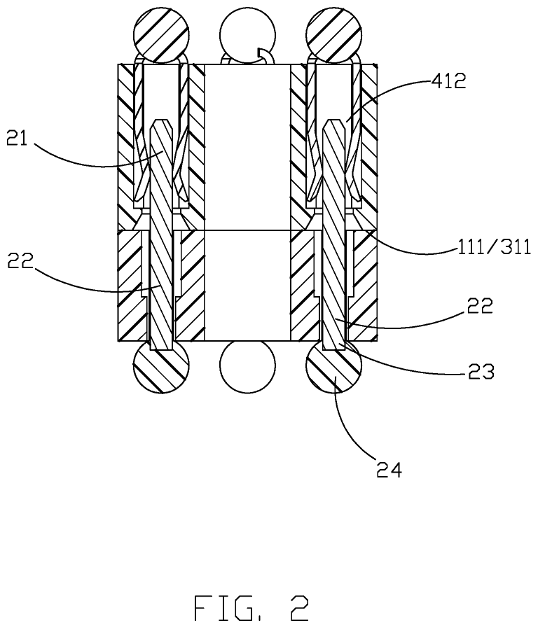

Referring to FIGS. 1 and 2, the insulating housing 10 has three rows of passageways (not labeled) running through a mounting face 112 and the mating face 111, in this embodiment, the mounting face 112 is on a lower face of the insulating housing 10 to be mounted on the printed circuit board. The plug terminals 20 are of a blade shape, and each comprises a retaining portion 22 received and retained in the passageway, and a blade or plug contacting portion 21, and a leg portion 23 to be mounted on the printed circuit board by a soldering ball 24. The plug contacting portions 21 protrude beyond the mating face 111 of the insulating housing 10. In this embodiment, the contacting portions 21 are arranged in three rows and two outer rows are aligned with each other while the middle row is offset from the two outer rows. The retaining portion 22 are larger than the contacting portions 21 in a width direction of the plug terminals while same with the contacting portions 21 in a thickness direction of the plug terminals.

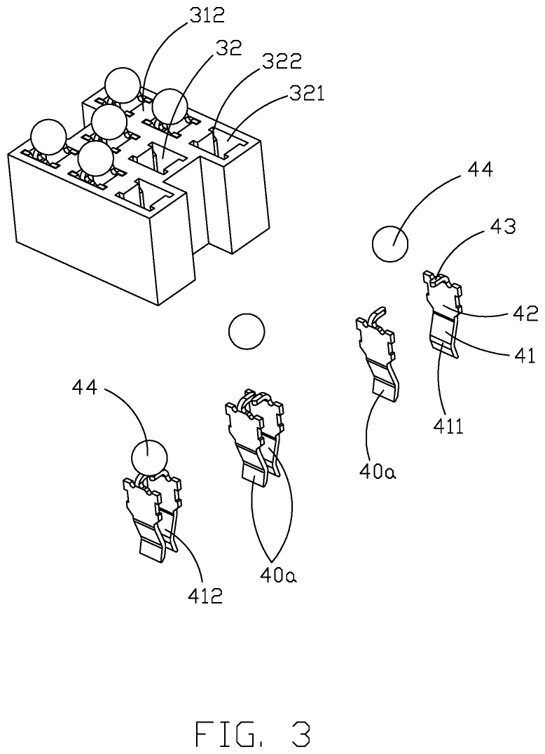

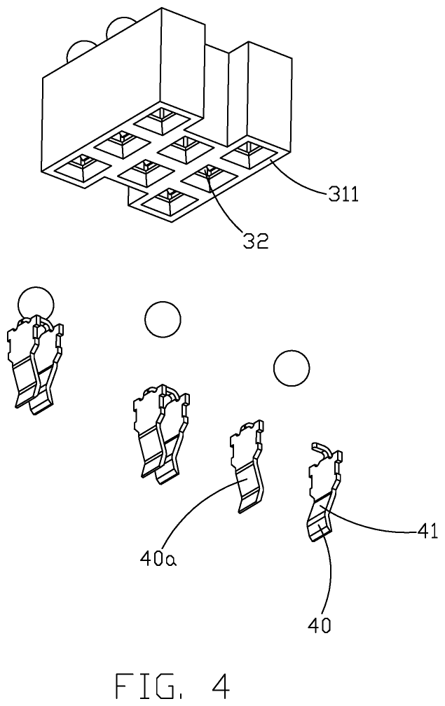

Referring to FIGS. 3-4, the insulating housing 30 has a plurality of passageways 32 running through the mating face 311 and a mounting face 312 opposite to the mating face 312. Each passageway 32 has one receiving holes 321 and two retaining slots 322 at opposite sides of the receiving hole 311. Each of the receptacle terminals 40 comprises two distinct terminal pieces 40a, each terminal piece 40a includes an elastic arm 41 with an arc contacting portion 411, a retaining portion 42 and a leg portion 43. The leg portion 43 and the elastic arm 41 extend from opposite edges of the retaining portion 42, the elastic arm 41 and the retaining portion 42 shares a same center axis, but the leg portion 43 is offset from the center axis. The two terminal pieces 40a are coupled to each other and define a mating cavity 412 between the two elastic arms 41. The two leg portions 43 extend toward to each other and are disposed parallel to each other to be soldered with one soldering ball 44. The retaining portions 42 are retained in the retaining slots 312, the two elastic arms 41 extend into the receiving hole 311. In this embodiment, the receptacle terminal 40 of pray construction is spit to two pray terminal pieces 40a, which benefit enlarger the width of the terminal, resulting enlarge the power delivery. The two terminal pieces 40a are same to each other.

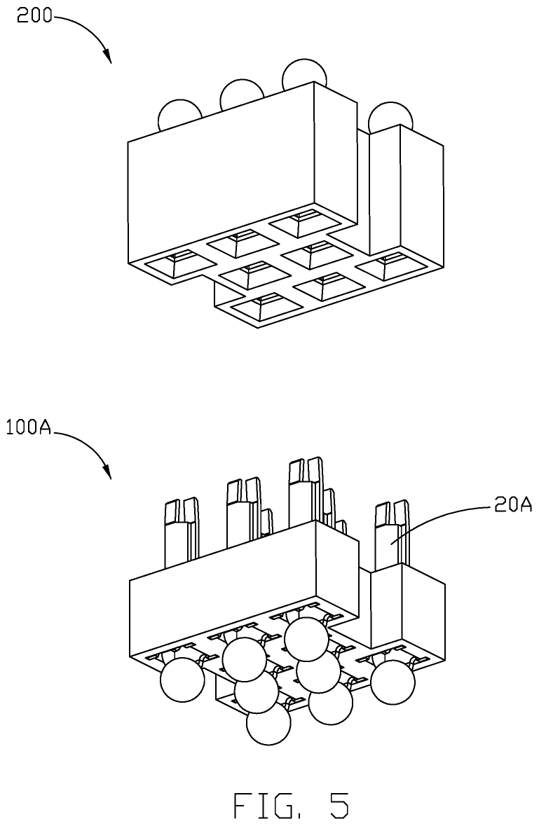

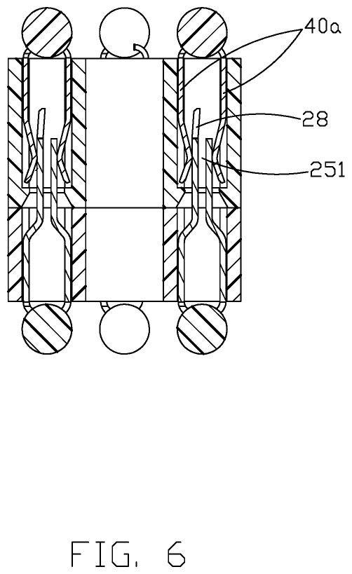

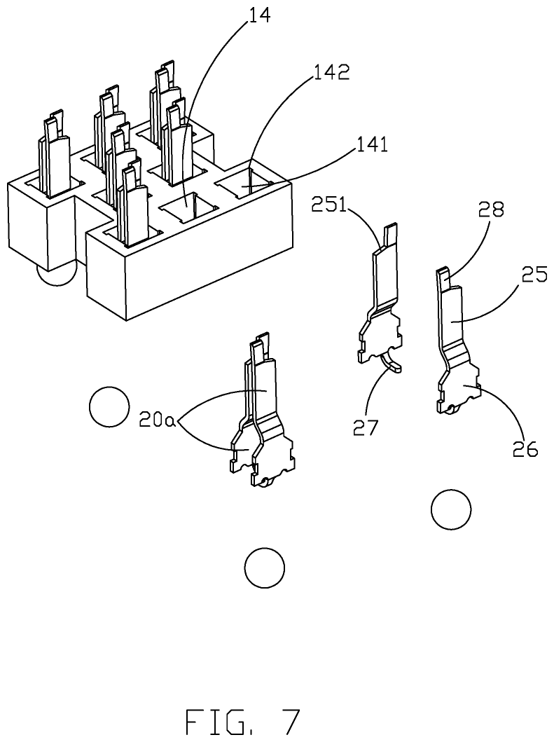

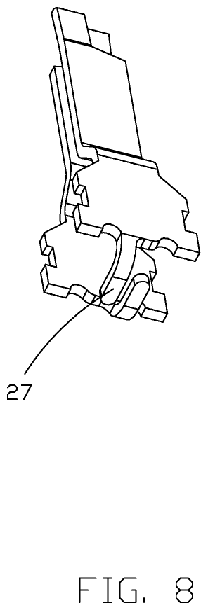

Referring to FIGS. 5-8 illustrating an electrical connector assembly of a second embodiment of this present invention, the receptacle connector 200 is same to that of the first embodiment, the plug connector 100A is similar to that of the first embodiment except the plug terminal 20A. The insulating housing 10 of the second connector 100A includes passageways 14; the passageway 14 includes a receiving hole 141 and two retaining slots 142. The plug terminal 20A is split to two distinct terminal pieces 20a, each terminal piece 20a includes a retaining portion 26, a plug or plate contacting portion 25 and a soldering portion 27 extending from opposite edges of the retaining portion 26. The retaining portions 26 are retained in the retaining slots 142. The two plug contacting portions 25 bend inward firstly and then extend upwards, so that the plug contacting portions 25 extend in the receiving hole 141. The two plug contacting portions 25 separate from each other with a gap 251. One guiding tab 28 extends upwards from the upper edge 251 of the contacting portion 25 as shown in FIG. 6. Each guiding tab 28 is located near one side of the upper edge of the contacting portion 25 and slant inward, that is, the two guiding tabs 28 are offset in the width direction, so that the two guiding tabs 28 of the receptacle terminal stagger from each other. The two plug contacting portions 25 are inserted into the mating cavity 251 defined between the two elastic arms 41. The upper edge of the contacting portion 25 adjacent to the guiding tab 28 becomes gradually lower.

However, the disclosure is illustrative only, changes may be made in detail, especially in matter of shape, size, and arrangement of parts within the principles of the invention.

What is claimed is:

1. A power connector assembly comprising:
a plug connector comprising an insulating housing defining a mating face and a mounting face opposite to the mating face and having a plurality of retaining passageways, and a plurality of plug terminals each comprising a retaining portion retained in the passageways, a blade contacting portion extending from the retaining portion and protruding outwards the mating face of the insulating housing; and
a receptacle connector comprising an insulating housing defining a mating face and a mounting face opposite to the mating face and having a plurality of passageways and a plurality of receptacle terminals received in the passageways and hid below the mating face of the receptacle connector, each of the passageways comprising a receiving hole and two retaining slots;
wherein each of the receptacle terminals is composed of two distinct terminal pieces, each of the terminal pieces comprising a retaining portion retained in the retaining slot, an elastic arm with an arc contacting portion, and a leg portion extending out of the insulating housing of the receptacle connector, and the two elastic arms are located opposite to each other and commonly received in a corresponding one of the receiving holes.

2. The power connector assembly as claimed in claim 1, wherein the two terminal pieces of each of the receptacle terminals have same structure.

3. The power connector assembly as claimed in claim 1, wherein the elastic arm and the retaining portion share a central axis, and the leg portion is offset from the central axis.

4. The power connector assembly as claimed in claim 3, wherein the two leg portions bend towards each other and are disposed parallel to each other.

5. The power connector assembly as claimed in claim 1, wherein each of the plug terminals is composed with two plug terminal pieces, each of the plug terminal pieces comprises a retaining portion, a blade contacting portion and a leg portion, the two blade contacting portions of the plug terminal pieces are separate from each other by a gap.

6. The power connector assembly as claimed in claim 5, wherein a guiding tab extends from an upper edge of the blade contacting portion and slants toward another plug terminal piece.

7. The electrical connector as claimed in claim 6, wherein the guiding tab is located near to one side of the plug terminal piece so that the two guiding tabs of the plug terminal stagger from each other.

8. The power connector assembly as claimed in claim 7, wherein the two retaining portions of each receptacle terminal are separate from each other by a gap larger than that of the two blade contacting portions.

9. The power connector assembly as claimed in claim 5, wherein a width of the elastic arm is larger than a width of the blade contacting portion.

10. A power plug connector comprising:
an insulating housing defining a mating face and having a plurality of passageways running through the mating face, each of the passageways comprising a receiving hole and two retaining slots at opposite sides of the receiving hole; and
a plurality of plug terminals each received in a corresponding passageway;
wherein each of the plug terminals is composed of two distinct terminal pieces each comprising a retaining portion retained in a corresponding retaining slot, a blade contacting portion extending from the retaining portion and protruding out of the mating face, and a leg portion.

11. The power plug connector as claimed in claim 10, wherein each terminal piece comprises a guiding tab extending from an upper edge of the blade contacting portion and slanting toward another terminal piece.

12. The power plug connector as claimed in claim 11, wherein the guiding tab is located near one side of the terminal piece so that the two guiding tabs of the plug terminal stagger from each other.

13. The power plug connector as claimed in claim 12, wherein the upper edge of the contacting portion adjacent to the guiding tab becomes gradually lower.

14. The power plug connector as claimed in claim 10, wherein the two retaining portions of each plug terminal are separate from each other by a gap larger than that of the two blade contacting portions.

15. The power plug connector as claimed in claim 10, wherein the blade contacting portion has a width less than that of a corresponding retaining portion.
